(19) United States
(12) Patent Application Publication
(10) Pub. No.: US 2024/0192044 A1
(43) Pub. Date: Jun. 13, 2024

(54) MEASURING DEVICE WITH SELF-TEST FUNCTION

(71) Applicant: VEGA Grieshaber KG, Wolfach (DE)

(72) Inventors: René HERRMANN, Oberwolfach (DE); Manuel KAUFMANN, Berghaupten (DE); Christoph MUELLER, Oppenau (DE)

(73) Assignee: VEGA Grieshaber KG, Wolfach (DE)

(21) Appl. No.: 18/534,133

(22) Filed: Dec. 8, 2023

(30) Foreign Application Priority Data
Dec. 9, 2022 (DE) 10 2022 132 829.5

(51) Int. Cl. G01F 25/20; G01F 23/284

(52) U.S. Cl. CPC G01F 25/20; G01F 23/284

(57) ABSTRACT

A measuring device for process automation in an industrial or private environment is provided, including: a sensor circuit configured to detect one or more measured variables; and a control circuit configured to determine a measurement result from the detected one or more measured variables and to determine a difference between a temperature of the sensor circuit and a reference temperature detected during a calibration of a self-test function of the measuring device, the control circuit being further configured to perform a correction of the measurement result depending on the difference between the temperature of the sensor circuit and the reference temperature during execution of the self-test function. A method for performing a correction of a measurement result of a measuring device for process automation in an industrial or private environment is also provided.

### CROSS-REFERENCE TO RELATED APPLICATIONS

This application claims the benefit of priority under 35 U.S.C. § 119 from German Patent Application No. 10 2022 132 829.5 filed on 9 Dec. 2022, the entire content of which is incorporated herein by reference.

### TECHNICAL FIELD

The present invention relates to measuring device technology. In particular, the invention relates to a measuring device for process automation in an industrial or private environment, a method for carrying out a correction of a measurement result of a measuring device, a program element, and a computer-readable medium.

### BACKGROUND

Measuring devices are used for process automation in industrial or private environments. Such measuring devices have a sensor circuit that is, i.e., configured to detect one or more measured variables. The control circuit of the measuring device can then calculate a measurement result from these measured variables. This can be, for example, a fill level, a flow rate, a limit level, a temperature, or a pressure. The measurement result can reflect a single value, such as a temperature or a pressure, or a measurement curve, such as an echo curve or similar in the case of a level measuring device.

A self-test function can be provided to check whether the measuring device is working properly. Such a self-test function is used, for example, to detect whether the measurement result can be classified as correct or whether a measurement error must be assumed.

DE 10 2019 206 531 A1 describes a measuring device with a self-test function.

### SUMMARY

There may be a desired to provide a measuring device whose self-test function has a high degree of reliability.

This desire is met by the subject-matter of the independent patent claims. Further embodiments of the present disclosure result from the subclaims and the following description of embodiments.

A first aspect of the present disclosure relates to a measuring device for process automation in an industrial or private environment. It comprises a sensor circuit which is configured to detect, i.e., record one or more measured variables. In addition, a temperature sensor is provided, which is configured to detect, i.e., record a temperature of the sensor circuit. It should be noted at this point that the temperature sensor does not necessarily have to be integrated into the measuring device. It may also be provided outside the measuring device.

The measuring device has a control circuit that is configured to determine a measurement result from the measured variable(s) and to determine a difference between the (current) temperature of the sensor circuit and a reference temperature (of the sensor circuit) that was recorded during a calibration of a self-test function of the measuring device. The control circuit is also set up to perform a correction of the measurement result depending on the difference between the detected temperature and the reference temperature during the execution of the self-test function.

The correction of the measurement result may also be understood as temperature compensation.

The measurement result or at least one characteristic of the measurement result may, depending on the design of the measuring device, have a so-called temperature response. This refers to a dependence of the measurement result on the temperature of the sensor circuit. According to the present disclosure, this temperature dependence can now be compensated for. This is possible by also recording and storing the reference temperature when determining the reference value of the test signal during the calibration process. By comparing the current sensor temperature with the stored reference temperature, a temperature difference can be determined and the measured value or the measurement result can then be compensated with a compensation characteristic.

According to an embodiment, the temperature of the sensor circuit is recorded while the self-test function is being carried out.

According to a further embodiment, the control circuit is set up to determine a difference between the corrected measurement result and a reference measurement result that was determined during a calibration of the self-test function of the measuring device.

According to a further embodiment, the control circuit is configured to output a warning signal when a malfunction of the measuring device is detected during the determination of the difference between the corrected measurement result and the reference measurement result.

According to a further embodiment, the temperature sensor is integrated in the measuring device.

According to a further embodiment, the measuring device is configured as a level measuring device, point or limit level measuring device, temperature measuring device, pressure measuring device, and/or flow measuring device.

For example, it is a level radar device, whereby the measurement result is an echo curve determined with the sensor circuit of the measuring device.

According to a further embodiment of the present disclosure, the measuring device is configured to trigger and/or start the execution of the device self-test based on a currently determined measurement result. According to a further embodiment, the control circuit is arranged to output an error message and/or not to perform or to limit the correction of the measurement result if the difference between the detected temperature of the sensor circuit and the reference temperature exceeds a predetermined threshold value.

According to a further aspect, a method for carrying out a correction of a measurement result of a measuring device for process automation in an industrial or private environment is provided, in which one or more measured variables are first recorded. The temperature of a sensor circuit of the measuring device is also recorded and a measurement result is determined from the recorded measured variable(s). Before, after or simultaneously with this, a difference is determined between the recorded temperature and a reference temperature that was recorded during a calibration of a self-test function of the measuring device. The measurement result is then corrected as a function of the difference between the detected temperature and the reference temperature during the execution of the self-test function. Another aspect of the present disclosure relates to a program element which, when executed on a control circuit of a measuring device, causes the measuring device to perform the steps described above and below.

A further aspect relates to a computer-readable medium on which a program element described above is stored.

According to an embodiment, the control circuit is set up to perform a device self-test to check a function, a correct function, a functionality, and/or a proper functioning of the measuring device. The control circuit is configured to determine a measurement result based on a measurement of the measured variable carried out with the sensor circuit in order to carry out the device self-test and/or when carrying out the device self-test and to compare the determined measurement result with at least one test parameter for the measurement result and/or at least one limit value for the measurement result. The at least one test parameter and/or the at least one limit value is defined, adapted, and/or determined as a function of an application of the measuring device and/or as a function of a device version of the measuring device.

By carrying out the device self-test (hereinafter also referred to as self-test) using the test parameter and/or limit value defined as a function of the application and/or device version, a device-specific and/or application-specific self-test may be carried out in an advantageous manner. This means that not only a general test of device functionalities can be carried out, but also a specific function test for the respective device version and/or application of the measuring device. The quality of the self-test can thus be significantly improved and the added value of this self-test, for example, for a user, customer, and/or user, can be increased. The self-test can thus be much more meaningful and therefore enable early detection of a malfunction of the measuring device, for example, detection of an impending device failure.

The measuring device may generally be any field device for recording the measured variable and/or a process variable. For example, the measuring device can be a level measuring device, a radar level measuring device, a point or limit level measuring device, a temperature measuring device, a pressure measuring device, and/or a flow measuring device. However, the measuring device can also be any other field device. The measured variable can be, for example, a level of a medium, a limit level of a medium, a temperature of a medium, a flow rate of a medium, a pressure of a medium, and/or any other process variable or process measured variable.

In the context of the present disclosure, the measurement result may be, for example, a measured value, a measurement curve, and/or a measurement series.

In general, the application of the measuring device may be representative of a use of the measuring device at a measuring location and/or at a measuring point. The application can thus designate an actual application of the measuring device, a use of the measuring device, and/or a deployment of the measuring device. Alternatively or additionally, the application of the measuring device may be representative and/or indicative of a measuring point, a measuring location, a measuring environment, or the like. For example, the use of the measuring device may describe a use of the measuring device outdoors, a use of the measuring device in an enclosed space, a use of the measuring device in a container, a use of the measuring device on a container, a use of the measuring device on a bulk material stockpile, or the like.

The device design of the measuring device can define, for example, a structure of the measuring device, a construction of the measuring device, the use of one or more components of the measuring device, such as an antenna and/or an antenna type, an attachment to the measuring device, or the like.

In the context of the present disclosure, the at least one test parameter can denote a device-specific and/or application-specific test parameter. The test parameter may be adapted and/or tuned with respect to the application and/or the device design.

In particular, the at least one test parameter may be representative and/or descriptive of the measurement result and/or the measured variable. For example, the test parameter can be representative of a characteristic of the measurement result, the measurand, and/or the measuring device. In other words, the test parameter can describe a characteristic of the measurement result, the measurand, and/or the measuring device. Alternatively or additionally, the test parameter can be representative of an expected measurement result. For example, if the measurement result is a measurement curve, such as an echo curve, the test parameter can be representative of a course of the measurement curve, such as in a predetermined and/or specific value range. For example, the test parameter can be representative of an amplitude of the measurement curve, a slope of the measurement curve or the like. Alternatively or additionally, the test parameter can describe a characteristic of the measured variable itself. For example, if the measured variable is the level of a medium, this can be represented and/or taken into account in the test parameter.

In the context of the present disclosure, the at least one limit value can designate a device-specific and/or application-specific limit value of the measurement result, which is adapted and/or tuned with regard to the application and/or the device design. In this context, the at least one limit value can designate and/or define a limit value range within which the measurement result lies and/or is to be expected when the measuring device is functioning correctly.

According to an embodiment, the at least one test parameter and/or the at least one limit value is stored in a data memory of the measuring device. At least one test parameter and/or limit value can be stored in the data memory for several different applications and/or device versions. The control circuit can, for example, be set up to determine the at least one test parameter and/or limit value suitable for the corresponding application and/or device version based on and/or taking into account the application and/or device version. Alternatively or additionally, the at least one test parameter and/or limit value can be selected and/or activated by a user, for example, via a user interface of the measuring device, according to the respective application and/or device version. This can allow users to independently perform and/or adapt the device self-test, for example, if a measuring environment, the device design, the application, and/or use of the measuring device changes.

According to an embodiment, the control circuit is set up to receive and/or retrieve the at least one test parameter and/or the at least one limit value remotely via a communication module of the measuring device, for example, from a server, an operating device and/or a control center. Any communication standards can be used for this purpose. The remote query can be wired and/or wireless. Communication and/or data transmission by means of the communication module can take place via Ethernet, Profibus, Foundation Fieldbus, Modbus, EthernetIP, Profinet, HART, Bluetooth, WLAN, LoRa, GSM, GPRS, UMTS, LTE, 3G, 4G, 5G, or any other communication standard, for example.

According to an embodiment, the at least one test parameter is representative of an amplitude of the measurement result, a frequency of the measurement result, a frequency range of the measurement result, a dead band of the measuring device, a background noise of the measurement result, an input ringing of the measuring device, a course of the measurement result as a function of a frequency of the measurement result, a course of the measurement result as a function of a distance to the measuring device, a time course of the measurement result, an expected measurement result, and/or an expected value of the measurement result.

According to an embodiment, the control circuit is also set up to output a warning signal, a warning, and/or a fault message if a malfunction is detected during the device self-test. The warning signal can be optical, acoustic, and/or electronic. For example, a warning signal can be output on a display and/or a display unit of the measuring device. Alternatively or additionally, the measuring device can be set up to send and/or transmit the warning signal to a receiver, for example, to a server, an operating device and/or a control center. In this way, a malfunction of the measuring device can be detected at an early stage and communicated to a user. The warning and/or fault message resulting from this self-test can, for example, provide early warning of an impending device failure. Among other things, this can prevent a production standstill due to a malfunction of the measuring device.

According to an embodiment, the measuring device is designed as a radar level measuring device for determining the level of a medium, with the measurement result being an echo curve determined by the sensor circuit of the radar measuring device.

According to an embodiment, the at least one test parameter is representative of a course of the echo curve in a close range of the measuring device. Alternatively or additionally, the at least one limit value defines an amplitude range within which the echo curve runs when the measuring device is functioning correctly. The echo curve can generally be a signal strength and/or amplitude of a radar signal reflected on the medium as a function of a distance to the measuring device. By checking the course of the echo curve at close range, a ringing, and/or input ringing can be advantageously checked. The ringing and/or input ringing can refer to echoes or reflections of the radar signal on the sensor itself, for example, on a part of the antenna, and/or on reflectors in the immediate vicinity of the measuring device, for example, on a fastening device for fastening the measuring device to a container. By checking the course of the echo curve at close range, it is possible, for example, to detect adhesion and/or contamination of an antenna at an early stage. This means that countermeasures can be taken, if necessary, before a device failure and/or incorrect measurement occurs. The measuring device can also be set up to determine the degree of soiling of the antenna of the measuring device.

According to an embodiment, the at least one test parameter is a background noise of the echo curve. Alternatively or additionally, the at least one limit value defines an amplitude range within which the echo curve runs when the measuring device is functioning correctly. The background noise can, for example, denote an amplitude and/or signal strength of the echo curve in an average distance range. The background noise can change if the measuring device is impaired, for example, if the antenna of the measuring device is clogged and/or soiled, which can be detected reliably and at an early stage using the device and/or application-specific device self-test.

According to an embodiment, the at least one test parameter and/or the at least one limit value is determined as a function of a transmission frequency of the radar level measuring device, as a function of an antenna type of an antenna of the radar level measuring device, as a function of a size of an antenna of the radar level measuring device, as a function of a shape of an antenna, as a function of a length of a cable probe of the radar level measuring device, as a function of a type of medium, as a function of a measuring environment and/or as a function of a measuring point. This can make it possible to define the device self-test comprehensively for the application intended for the measuring device and/or for the respective device version. For example, different antennas, antenna sizes, and/or antenna types can be used for different applications in radar level measuring devices, which can be taken into account in the at least one test parameter. This means that the device self-test can be adapted to the respective application and/or device design by selecting the appropriate at least one test parameter. Overall, this can significantly increase the informative value of the device self-test.

According to an embodiment, the control circuit is set up to detect adhesion to and/or contamination of an antenna of the radar level measuring device based on the device self-test. If the build-up and/or contamination is detected, the measuring device can automatically issue a warning, a warning signal, and/or a fault message, in particular, before a device failure is imminent. For example, the measuring device can indicate to a user in good time that the antenna needs to be cleaned. Overall, this can ensure trouble-free measurement operation.

According to an embodiment, the measuring device is configured to trigger and/or start the device self-test based on a currently determined measurement result. For example, the measuring device can be designed as a radar level measuring device and determine that the container to be measured is essentially empty based on an evaluation of an echo curve. If the measuring device determines that the container is currently essentially empty, the measuring device can, in response, perform a device self-test for the close range of the measuring device, for a ringing, an input ringing, and/or a background noise of the measuring device, for example, because such a check can be performed with increased accuracy for an empty container.

Aspects of embodiments and their advantages are summarized below. The present disclosure may enable a user of the measuring device, such as a customer, to use the measuring device to perform a device-specific and/or application-specific self-test via one or more functionalities of the measuring device. The at least one test parameter and/or limit value required for this and/or the associated at least one test parameter and/or limit value can be configured specifically for the measuring device, for example, depending on the respective device version and/or application, which can be set and/or determined on the measuring device, for example. This specific at least one test parameter and/or limit value can be written to a data memory of the measuring device during a test during production of the measuring device and/or before shipping. If a better test parameter and/or limit value is available at a later time, for example, due to new findings and/or experience, and/or after changes to the measuring device and/or the application itself, this can be transferred to the measuring device by remote query. In this way, the self-test can be updated for the customer or user. The self-test can therefore no longer just be a general test of the device functions, but an absolutely specific function test for the respective device version and/or application of the user or the measuring device. The quality of the self-test can therefore be significantly higher and the added value of this test for the user much greater. The results, warnings, and error messages resulting from this self-test can be much more meaningful and can warn the user at an early stage, e.g., of an impending device failure. The self-test can also be carried out automatically at regular intervals defined by the user. If, for example, the measuring device is switched to a different application and/or if a change is made to the device design, such as a modification of the measuring device, the least one test parameter and/or limit value can be adjusted and/or selected accordingly, for example, by the user himself (e.g., via a user interface of the measuring device). The specific test parameters and/or limit values can thus always be available to the user. The self-test can also be carried out during production of the measuring device, which can reduce testing times. New test parameters and/or limit values for the self-test can also be incorporated directly into production so that no new firmware version is required, for example. The customer and/or user can thus be enabled to carry out a self-test specific to their measuring device after purchasing the measuring device, in which the at least one test parameter and/or limit value for carrying out the self-test is configured specifically for their device version and/or application.

### BRIEF DESCRIPTION OF THE FIGURES

Further embodiments of the present disclosure are described below with reference to the figures. The illustrations in the figures are schematic and not to scale. If the same reference signs are used in the following figures, these designate the same or similar elements.

FIG. 1 shows a flow chart of a process according to an embodiment;

FIG. 2 shows a flow diagram according to a further embodiment;

FIG. 3 shows an example of a temperature curve of a measurement result and a compensation characteristic; and

FIG. 4 shows a measuring device according to an embodiment.

### DETAILED DESCRIPTION OF EMBODIMENTS

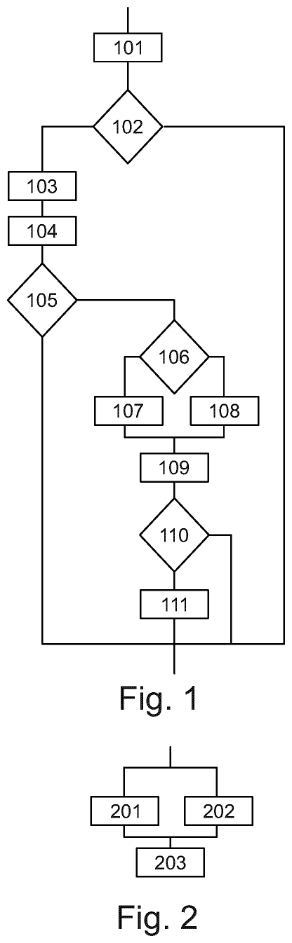

FIG. 1 shows a flow diagram of a method according to one embodiment. In step 101, one or more measured variables are determined, from which a measurement result or measured value is then calculated. This takes place during the execution of a self-test function. In step 102, a discriminator is activated which decides whether temperature compensation is active. If this is not the case, the procedure ends. If temperature compensation is active, the temperature of the measuring device is determined by one or more temperature sensors in step 103. These temperature sensors can be located at different places, for example, in the container in which the measuring device is arranged and/or in the measuring device itself.

In step 104, the temperature difference between the temperature during the calibration process and the current temperature just measured is determined. In step 105, the temperature difference is validated, for example, by carrying out a plausibility check from −100 degrees to +100 degrees. In step 106, it is determined whether the temperature difference is positive or negative. In step 107 (in the case of a negative temperature difference), a compensation function or compensation characteristic is selected for a negative temperature difference. Alternatively (in the case of a positive temperature difference), a compensation curve or compensation characteristic for a positive temperature difference is selected in step 108.

The measurement result or the measured value is then corrected in step 109 using the selected compensation curve/characteristic and the compensated/corrected measurement result or the compensated/corrected measured value is validated in step 110. This validation takes place as part of the execution of the self-test function of the measuring device. In step 111, error handling takes place if the measured value is outside a valid range after compensation. Examples of this are the triggering of a fault message or the switching of the sensor output to a fault mode.

FIG. 2 shows another flow chart. In step 201, the measured value or measurement result of a sensor measurement is determined when the self-test function is executed. In step 202, which can run parallel to step 201, the current sensor temperature is determined. This is followed in step 203 by saving the determined sensor temperature in the form of a temperature reference value in the sensor or an external storage location, such as a cloud.

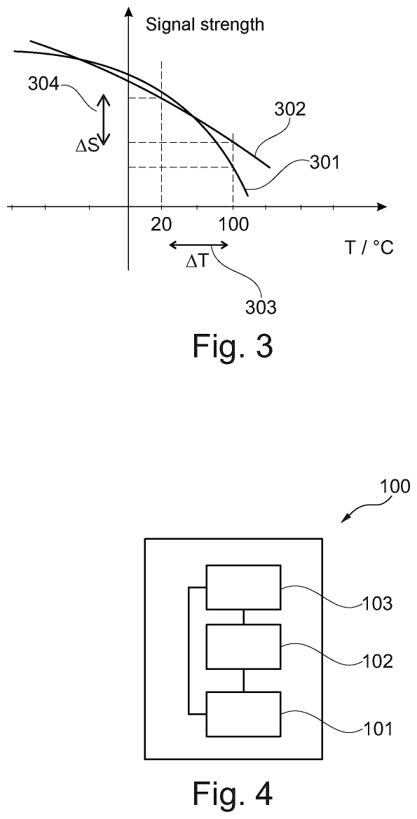

FIG. 3 shows the dependence of the signal strength of the measurement result on the temperature of the sensor circuit. A temperature of 20° C. is assumed to be the normal temperature or reference temperature. The self-test function of the measuring device is calibrated at this temperature. The curved curve 301 shows the actual temperature response of the signal strength. The signal strength decreases increasingly sharply as the temperature rises. Curve 302 shows an example of a corresponding compensation curve. The compensation characteristic 302 is linear or has a nearly linear curve. If a temperature of 100° C. is detected during a measurement, this results in a temperature difference ΔT of 80° C. This temperature difference corresponds to a difference ΔS in the signal strength. The measurement result can now be increased by ΔS.

FIG. 4 shows a measuring device 100 according to one embodiment. The measuring device 100 has a sensor circuit 101, a temperature sensor 102, and a control circuit 103, which is connected to the temperature sensor 102 and the sensor circuit 101. The temperature sensor 102 measures the current temperature in the area of the control circuit 101 and transmits this temperature value to the control circuit 103.

In particular, the measuring device 100 can be designed as a level measuring device, for example, as a level radar measuring device, and can perform a temperature-compensated device self-test and a corresponding procedure, as described above. In particular, the device temperature is determined by one or more internal and/or external temperature sensors during the calibration process of the self-test function. The temperature value of the calibration process is stored in the sensor. During a subsequent measurement, the current sensor temperature is determined, in particular during a self-test of the measuring device, as well as the resulting temperature difference at the time of calibration.

Based on the temperature difference when performing the self-test in relation to the temperature during the calibration process, one or more features of the measured value/measurement result are compensated using a temperature-dependent compensation characteristic.

The temperature-compensated characteristic of the measured value can be checked with a reference value of the characteristic of the measured value during the self-test.

The compensation curve does not necessarily have to correspond to the actual temperature curve or be identical to it, as shown in FIG. 3. A sufficiently accurate approximation is also sufficient, for example, a linear compensation characteristic despite an actual non-linear temperature curve.

The compensation characteristic can be available as a “look-up table”, for example, or the compensation values can be determined by calculation. This is particularly possible in the case of linear compensation with little computational effort. A calculation rule in the form of a formula can also be used.

The temperature compensation described above can be switched on and off. This can save energy. It is also possible for the implementation of temperature compensation to be dependent on certain device variants. It is also possible that only the amplitude of the test signal is temperature compensated. It is possible that the temperature reference value is determined by averaging the temperature. It can be stored in the EEPROM. The stored temperature reference value can be protected by means of a CRC (Cyclic Redundancy Check). It is also possible to store a temperature reference value for one or more sensor settings.

The compensation characteristic may be adjustable. The compensation characteristic can be linear or of order N. The compensation characteristic may vary for one or more sensor settings.

A downstream limit value check can limit the compensation of the measured value. An excessive temperature difference in relation to the temperature reference value can lead to an error message and compensation can be prevented or limited in this case.

A hysteresis in the sense of an application of threshold values (in the value range or in time) can be provided for the output of the error message. Depending on a positive and/or negative temperature difference, the temperature compensation can be switched to active or inactive. For example, a temperature of 20° C. can be provided as the default value for the temperature reference value.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A measuring device for process automation in an industrial or private environment, comprising:
a sensor circuit configured to detect one or more measured variables; and
a control circuit configured to determine a measurement result from the detected one or more measured variables and to determine a difference between a temperature of the sensor circuit and a reference temperature detected during a calibration of a self-test function of the measuring device,
wherein the control circuit is further configured to perform a correction of the measurement result depending on the difference between the temperature of the sensor circuit and the reference temperature during execution of the self-test function.

2. The measuring device according to claim 1,
wherein the temperature of the sensor circuit is detected before, after, or during the execution of the self-test function.

3. The measuring device according to claim 1,
wherein the control circuit is further configured to determine a difference between the corrected measurement result and a reference measurement result determined during a calibration of the self-test function of the measuring device.

4. The measuring device according to claim 3,
wherein the control circuit is further configured to output a warning signal and/or a fault signal when a malfunction is detected in connection with the determination of the difference between the corrected measurement result and the reference measurement result.

5. The measuring device according to claim 1,
wherein the measuring device is configured as a level measuring device, a point level measuring device, a temperature measuring device, a pressure measuring device, and/or a flow measuring device.

6. The measuring device according to claim 1,
wherein the measuring device is a level radar device, and
wherein the measurement result is an echo curve determined with the sensor circuit of the measuring device.

7. The measuring device according to claim 1,
wherein the measuring device is configured to trigger and/or start the execution of the self-test function based on a currently determined measurement result.

8. The measuring device according to claim 1,
wherein the control circuit is further configured to output an error message and/or not to perform or limit the correction of the measurement result if the difference between the temperature of the sensor circuit and the reference temperature exceeds a predetermined threshold value.

9. The measuring device according to claim 1, further comprising a temperature sensor configured to detect the temperature of the sensor circuit.

10. The measuring device according to claim 9,
wherein the temperature sensor is integrated in the measuring device.

11. A method for performing a correction of a measurement result of a measuring device for process automation in an industrial or private environment, comprising the steps of:
detecting one or more measured variables;
detecting a temperature of a sensor circuit of the measuring device;
determining a measurement result from the measured variable(s);
determining a difference between the detected temperature and a reference temperature that was detected during a calibration of a self-test function of the measuring device; and
performing a correction of the measurement result depending on the difference between the detected temperature and the reference temperature during the execution of the self-test function.

12. A nontransitory computer-readable medium having stored thereon instructions that, when executed on a control circuit of a measuring device, causes the measuring device to perform the following steps:
detecting one or more measured variables,
detecting a temperature of a sensor circuit of the measuring device,
determining a measurement result from the measured variable(s),
determining a difference between the detected temperature and a reference temperature that was detected during a calibration of a self-test function of the measuring device, and
performing a correction of the measurement result depending on the difference between the detected temperature and the reference temperature during the execution of the self-test function.
